(19) United States
(12) Patent Application Publication
(10) Pub. No.: US 2011/0164534 A1
(43) Pub. Date: Jul. 7, 2011

(54) METHOD OF PROVIDING A MESSAGE WAIT SERVICE TO THE USERS OF AN INTERNET PROTOCOL BASED TELECOMMUNICATION NETWORK

(76) Inventors: Narayanan Vaishnavi, Chennai (IN); Andreas Schwab, Stuttgart (DE); Johan Dries, Herentals (BE); Ramachandran Gopannan, Chennai Tamilnadu (IN); Bruno Borgogni, Palazzolo (IT); Cornelius Schuttack, Kornwestheim (DE)

(21) Appl. No.: 12/451,984

(22) PCT Filed: Oct. 12, 2007
(86) PCT No.: PCT/EP2007/060893

§ 371 Date: Sep. 14, 2010

(30) Foreign Application Priority Data
Jul. 6, 2007 (IN) 1457/CHE/2007

(51) Int. Cl. H04Q 11/04

(52) U.S. Cl. 370/259

(57) ABSTRACT

A method is disclosed of providing a message wait service to the users of an IP based telecommunication network (IPBN). For the invocation of a message wait service by a calling user, when said VOIP user is busy or not answering a call, or has forwarded all the calls unconditionally to a voice mail server, the method comprises the steps of:
sending (201) from a proxy server (104), which takes care of redirecting the calls of said VOIP user (100), to a media gateway controller (102) of the IP based telecommunication network (IPBN), a message INVITE comprising a diversion header containing a diversion reason: user-busy, or no-answer;
generating, in said media gateway controller (102), some procedure code for invocation of a message wait service provided by a voice mail server (151) in a time division multiplex network (PSTN), when said media gateway controller (102) receives said message INVITE;
and then sending (202, 203) said procedure code, in an IAM message, towards said voice mail server (151) of said time division multiplex network (PSTN).

### BACKGROUND OF THE INVENTION

### Field of the Invention

The invention relates in particular to a method of providing a Message Wait Service (MWS) to the users of an Internet Protocol (IP) based telecommunication network. A MWS provides, to the served users, the capability of redirecting their speech calls towards an external system able to record spoken messages, and which is called Voice Mail Server (VMS). These messages are stored into a subscribers voice mailbox. If the service is active, the redirection of a call is done when one of the following events occurs:
called user is busy,
called user doesn't reply in a certain period,
or unconditional forwarding to VMS is activated.

The called user is notified by the VMS when at-least one message is waiting. Once the subscriber listens to all messages in the mailbox, notification is sent that there are no more messages waiting. This MWS is available for users of a TDM telephone network by using a TDM VMS. Such VMS are currently available in the TDM public switched telephone networks, as well as in the TDM private switched telephone network.

Recent networks are based on the Internet Protocol (IP) and are using the signaling protocol SIP (Session Initiation protocol). The VOIP (Voice Over Internet Protocol) technology is used for telephony in these IP based networks. The subscribers use SIP phones. A Message Wait Service can be made available to SIP phone subscribers, with the same ergonomics as in the TDM networks. An IP-based VMS can be used to provide the Message Wait Service to SIP phone subscribers. For providing this service in an IP based network, we need to bring in new network elements, with additional hardware and software cost (and additional operational expenditure for maintenance, etc.). It would be less expensive to use a TDM VMS of an already existing in TDM network. In TDM networks, signaling is based on Signaling System No. 7 (SS7) i.e., using the signaling protocol Transaction Capabilities application Part (TCAP) or ISDN User Part (ISUP). Unfortunately no interface, between a TDM network and an IP based network, enabling the access to a TDM VMS, is currently standardized and available. So, IP-based network subscribers would not be able to use the MWS of a TDM network.

The object of the invention is to enable IP-based network subscribers to use the MWS of a TDM network.

### SUMMARY OF THE INVENTION

The invention provides a method of providing a message wait service to a VOIP user in an IP based telecommunication network, characterized in that, for the invocation of a message wait service by a calling user, when said VOIP user is busy or not answering a call, or has forwarded all the calls unconditionally to a voice mail server, it comprises the steps of:
sending from a proxy server, which takes care of redirecting the calls of said VOIP user, to a media gateway controller of the IP based telecommunication network, a message INVITE comprising a diversion header containing a diversion reason: user-busy, or no-answer;
generating, in said media gateway controller, some procedure code for invocation of a message wait service provided by a voice mail server in a time division multiplex network, when said media gateway controller receives said message INVITE;
and then sending said procedure code, in an IAM message, towards said voice mail server of said time division multiplex network. Other characteristics of the method according to the invention will appear in the following pages.

By these steps, the claimed method inter-works the signalling protocols of a TDM based network and an IP based network, for the commands necessary to provide the MWS to VOIP user by using an already existing TDM voice mail server.

The invention also provides a device comprising processing means adapted to perform the steps of the method according to the invention.

### BRIEF DESCRIPTION OF THE DRAWINGS

FIG. 1 represents an example of a TDM public switched telephone network, and an example of an IP based network, the latter comprising a device performing the steps of the method according to the invention.

FIG. 2 represents the exchanges of messages in one embodiment of the method according to the invention, with a SS7/SIP interface, for invocation of MWS in TDM VMS by a calling user, when a VOIP user is busy or not answering a call, or has forwarded all the calls unconditionally to VMS. The exchange of messages is similar for the interrogation of the VMS by a VOIP user.

FIG. 3 represents the exchanges of messages in one embodiment of the method according to the invention, with a SS7/SIP interface, for the Message Wait Indication (MWI) from a TDM network towards a VOIP user in an IP based network, for indicating that a message is waiting, or no more messages waiting.

FIG. 4 represents the exchanges of messages in one embodiment of the method according to the invention, with a SS7/SIP interface, for an interrogation procedure when a VOIP user, in an IP based network, wants to listen to the voice messages stored in a corresponding mailbox, in the VMS of a TDM network.

FIG. 5 represents the exchanges of messages in another embodiment of the method according to the invention, with a TCAP/SIP interface, for sending a Message Wait Indication (MWI) from a TDM network towards a VOIP user in an IP based network, for indicating that a message is waiting, or no more messages waiting.

### DETAILED DESCRIPTION OF THE PREFERRED EMBODIMENT

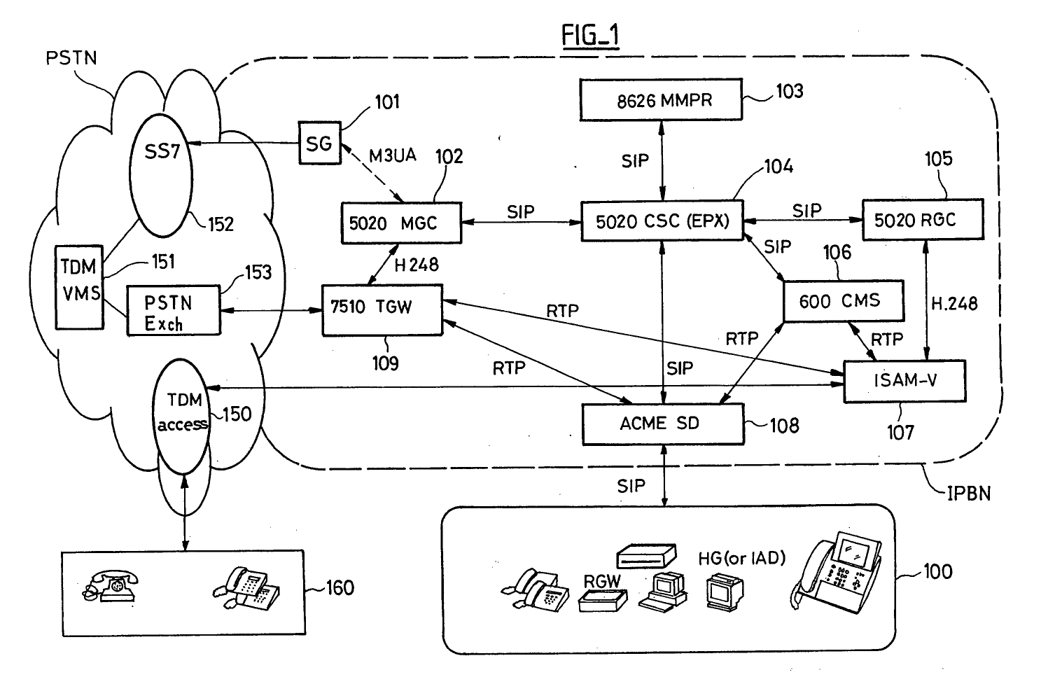

On FIG. 1, the example, referenced PSTN, of a TDM public switched telephone network comprises:
a TDM access node 150,
a SS7 signaling point 152,
a TDM exchange 153,
and a TDM VMS server 151.
   Analog and ISDN phones 160 are linked to the TDM access node 150 of the TDM network PSTN.

The example, referenced IPBN, of an IP-based network comprises:
A signaling gateway 101 which receives SS7 signalling over a standard SS7 interface, and forwards it over a M3UA interface
A media gateway controller 102.
A multimedia phone residential 103 which is a SIP based application server.
An extended proxy server 104, which is a SIP proxy server.
A residential gateway controller 105.
A media server 106.
An ISDN access module 107.
A session border control software platform 108.
A trunking gateway 109.
   SIP terminals 100, in particular SIP phones, are linked to the session border control software platform 108 of the IP-based network IPBN.

The trunking gateway 109 supports only bearer traffic (no signalling traffic). For instance, it is a trunking gateway 7510 TGW marketed by Alcatel-Lucent. It has Real Time Transfer Protocol (RTP) interfaces to communicate with the ISDN access module 107 and with the session border control software platform 108. It has a H.248 interface to communicate with the media gateway controller 102. This latter has a SIP interface to communicate with the extended proxy server 104.

The signaling gateway 101 receives SS7 signalling over a standard SS7 interface, and forwards it over a Message Transfer Part 3 User Adaptation (M3UA) interface, to the media gateway controller 102. The protocol M3UA supports the transport of any SS7 MTP3-User signalling (such as ISUP and SCCP messages) over IP, using the services of the Stream Control Transmission Protocol (SCTP). The protocol M3UA is used for communication between the Signalling Gateway 101 and the Media Gateway Controller 102. This latter uses SIP for communicating with the extended proxy server 104, and it uses the protocol H.248 to communicate with the trunking gateway 109.

The signaling gateway 101 and the media gateway controller 102 provide inter-working of SS7/TCAP/ISUP signalling protocols of the TDM network PSTN, with the SIP signalling protocol of the network IPBN. SIP inter-working follows RFC3842 for MWS in the media gateway controller 102. The description in the following sections is focusing on ISUP<->SIP interworking, however, the same method can be extended for TCAP<->SIP interworking also.

The extended proxy server 104 has SIP interfaces to communicate with: the media gateway controller 102, the multimedia phone residential 103, the extended proxy server 104, the residential gateway controller 105, the media server 106, and the control software platform 108.

The media server 106 provides announcements towards VOIP users in the network IPBN. It has RTP interfaces to communicate with the ISDN access module 107, and the session border control software platform 108. It has a SIP interface to communicate with the extended proxy server 104.

There are four cases basically involved in providing the MWS to the subscribers of the IP based network IPBN:
Invocation of VMS,
Message Wait Indication (MWI),
Interrogation of VMS,
Subscribe/Unsubscribe to VMS.

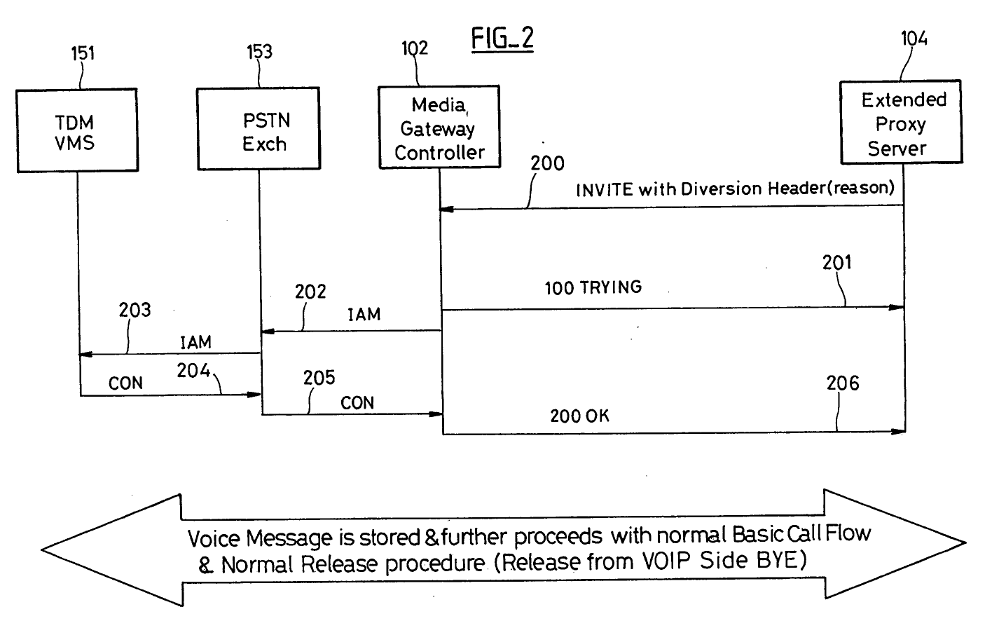

FIG. 2 represents the exchanges of messages for invocation of the TDM VMS 151 by a calling user, when a VOIP user, using an IP phone 100, is busy or not answering a call, or has forwarded all the calls unconditionally to VMS. The followings steps are executed:

200) The extended proxy server 104, which takes care of redirecting the call of the VOIP user to an appropriate destination, sends, to the media gateway controller 102, an INVITE message with call diversion information (transported over a diversion header with corresponding diversion reason: User-Busy or No-Answer) and with a destination number: the number of the TDM VMS 151. The media gateway controller 102 prepares an ISUP called party number (based on the info received in the SIP INVITE) with the corresponding procedure code for User busy/No answer. The media gateway controller 102 executes an interface algorithm to generate appropriate procedure code for invocation of TDM voice mail service.

201) The media gateway controller 102 acknowledges the receiving of the INVITE message by sending a message 100 TRYING, to the extended proxy server 104.

202) The media gateway controller 102 sends then the generated procedure code, in a message IAM, towards the TDM VMS 151 via the TDM switch 153 of the network PSTN, via the trunking gateway 101 and the media gateway controller 102 which are not represented on this FIG. 2. After this step, the classical call flow is applicable. For example:

203) The TDM exchange 153 forwards the message IAM to the TDM VMS 151

204) The TDM VMS 151 answers the call by sending a message CON (CONNECT) to the TDM exchange 153.

205) The TDM exchange 153 forwards the message CON to the media gateway controller 102.

206) The media gateway controller 102 sends a message 200 OK to the extended proxy server 104 which redirects the same message towards the served VOIP user.

Subsequently, the calling user records his/her voice message for the VOIP user, when the above steps have been executed, as a result of the call been forwarded to a voice mailbox, for instance. The voice Message is stored, and further proceeds with normal basic call flow and normal release procedure: The network IPBN sends a message BYE towards the VOIP user 100.

The exchange of messages is similar for the interrogation of the VMS by a VOIP user.

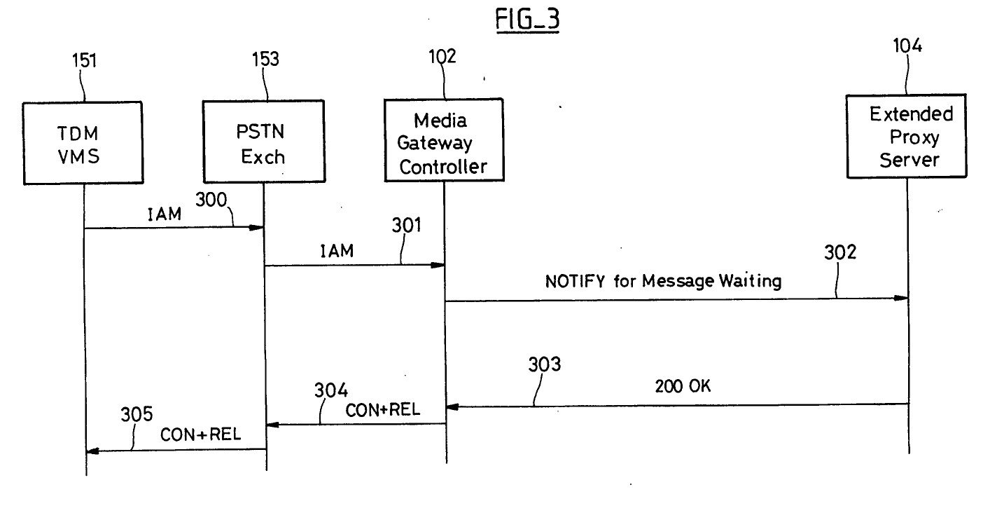

FIG. 3 represents the exchanges of messages in one embodiment of the method according to the invention, for sending a Message Wait Indication (MWI) from the TDM VMS 151 in the TDM network PSTN towards the extended proxy server 104 which forwards the same to the served VOIP user in the IP based network IPBN, for indicating that a message is waiting, or no messages waiting for him/her.

300) When at-least one unheard message is stored in the mailbox of the served VOIP user, the TDM VMS 151 (via SS7/ISUP/TCAP interface) sends the MWI, via the SS7 signaling point 152 TDM and the TDM exchange 153, as a message IAM carrying a notification of presence or absence of voice messages, with some respective procedure code for notification, along with called digits designating said VOIP user 100, along with Called Digits designating the served VOIP user (100).

301) The TDM exchange 153 forwards this message IAM to the media gateway controller 102, via the trunking gateway 101 and the media gateway controller 102 which are not represented on this FIG. 3.

302) The media gateway controller 102 forwards this MWI in a SIP message NOTIFY towards the extended proxy server 104 which redirects the same towards the VOIP user. This call is a no-ring, no-answer call. Media gateway controller 102 must have an interface algorithm to prepare this NOTIFY message instead of a normal INVITE message.

303) The extended proxy server 104, answers to a successful notification, at the served VOIP user side, by sending a message 200 OK, to the media gateway controller 102.

304) When it receives a 200 OK message, the interface algorithm of the media gateway controller 102 generates a message CON+REL (CONNECT and RELEASE) and sends it towards the TDM VMS 151 via the TDM switch 153. In case of any other response (failure) from the IP based network IPBN, the Interface algorithm of the media gateway controller 102 generates a message RELEASE with a failure cause value, and sends it towards TDM VMS 151, via the trunking gateway 101 and the media gateway controller 102.

305) The TDM switch 153 forwards the message generated by the media gateway controller 102 up to the TDM VMS 151.

Note: At step 303, the message 200 OK may not always be sent as response to message NOTIFY from Media gateway controller 102: For example, when a native SIP VOIP user is not registered. The media gateway controller 102 only generates a message RELEASE, without any message CONNECT, for any error response. The TDM VMS 151 may retry sending the MWI towards the VOIP user again.

When all messages stored in the mailbox have been heard, TDM VMS 151 (via SS7/ISUP/TCAP interface) informs media gateway controller 102 with a procedure code for “absence” of messages. The media gateway controller 102 forwards this peculiar MWI as a SIP message NOTIFY towards the extended proxy server 104, which forwards to the served VOIP user. This call is also a no ring call, no answer call. When successful notification happens, a SIP message CONNECT and RELEASE is sent by media gateway controller 102 towards the TDM VMS 151.

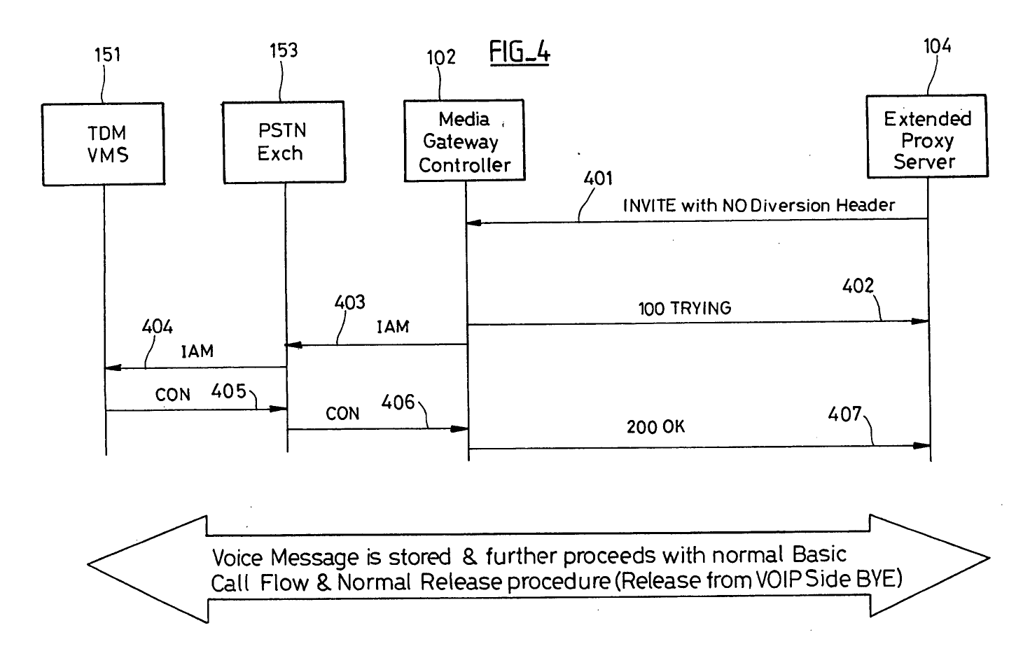

FIG. 4 represents the exchanges of messages in one embodiment of the method according to the invention, for the interrogation of TDM VMS 151 when a VOIP user wants to listen to the voice messages stored in his/her mailbox, in TDM VMS 151.

401) When the VOIP user wants to retrieve and listen to the voice messages, the extended proxy server 104 in charge of the VOIP user sends, to the media gateway controller 102, a SIP message INVITE initiated by the VOIP user and containing no diversion header. It is essential that an INVITE message without diversion header be received by the media gateway controller 102, to differentiate the invocation method from the interrogation method, as both methods are calls towards TDM VMS 151.

402) The media gateway controller 102 receives this message INVITE and acknowledges reception by sending a SIP message 100 TRYING, to the extended proxy server 104 which forwards it to the served VOIP user.

403) The media gateway controller 102 checks whether no diversion header is received in the INVITE message. If no diversion header is received in the INVITE message, the media gateway controller 102 generates a procedure code for interrogation of voice messages. This procedure code is forwarded in a message IAM towards the TDM VMS 151, via the TDM switch 153. The media gateway controller 102 has an interface algorithm to generate the appropriate procedure code for interrogation of voice messages.

404) The TDM switch 153 forwards the message IAM to the TDM VMS 151. After this step, the normal call flow is applicable: The user can navigate through a menu, listening messages one by one, etc. It proceeds with normal basic call flow and normal release procedure (SIP message BYE sent to the network IPBN).

The SIP Subscribe/Unsubscribe methods (according to RFC3842) can be used to provide the subscription in the TDM VMS, for the VOIP users.

A similar interfacing method can also be established between protocols TCAP and SIP, in any softswitch such as Alcatel-Lucent 5020 MGC.

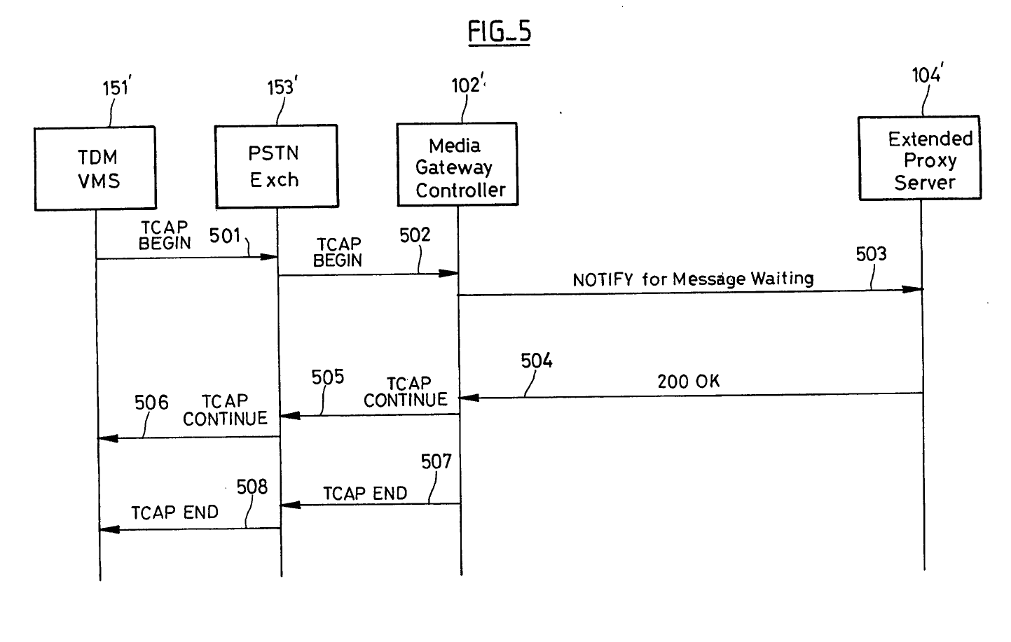

FIG. 5 represents the exchanges of messages in another embodiment of the method according to the invention, with a TCAP/SIP interface, for sending a Message Wait Indication (MWI) from a TDM VMS 151′ in a TDM network towards an extended proxy server 104′ which forwards the same to the served VOIP user in an IP based network, for indicating that a message is waiting, or no messages waiting for him/her.

501-502) The TDM VMS 151′ sends a Notification of Voice Message in a message TCAP BEGIN with a Procedure Code (Presence/Absence of voice message) along with Called Digits towards a media gateway controller 102′, via a TDM exchange 153′. The media gateway controller 102′ must have an Interface Algorithm to prepare a NOTIFY Message instead of normal INVITE, if it receives Called Digits containing the procedure Code for Notification.

503) Then the media gateway controller 102′ sends a SIP message NOTIFY towards an extended proxy server 104′.

504) The extended proxy server 104′ answers with a message 200_OK.

505-506) If it receives a 200_OK positive response, the Interface Algorithm of the media gateway controller 102′ generates a message TCAP CONTINUE & TCAP END (normal) towards the TDM VMS 151′, via the TDM exchange 153′.

507-508) In case of any other response (failure) from the IP based network, the Interface Algorithm of the media gateway controller 102′ generates only a message TCAP END with failure cause, and sends it towards the TDM VMS 151′, via the TDM exchange 153′.

The method according to the invention saves some cost of Installation because it uses an already installed TDM VMS equipment for providing Message Wait Service to SIP-subscribers of an IP-based network. This avoids the cost of installing a new SIP VMS. It is peculiarly valuable for incumbent telecom providers.

This method avoids any impact to the end users, i.e., the platform that provides this service is transparent to them (as there is no change in service characteristics).

There is claimed:

1) A method of providing a message wait service to a VOIP user in an IP based telecommunication network (IPBN), characterized in that, for the invocation of a message wait service by a calling user, when said VOIP user is busy or not answering a call, or has forwarded all the calls unconditionally to a voice mail server, it comprises the steps of:
sending (201) from a proxy server (104), which takes care of redirecting the calls of said VOIP user (100), to a media gateway controller (102) of the IP based telecommunication network (IPBN), a message INVITE comprising a diversion header containing a diversion reason: user-busy, or no-answer;
generating, in said media gateway controller (102), some procedure code for invocation of a message wait service provided by a voice mail server (151) in a time division multiplex network (PSTN), when said media gateway controller (102) receives said message INVITE;
and then sending (202, 203) said procedure code, in an IAM message, towards said voice mail server (151) of said time division multiplex network (PSTN).

2) A method according to claim 1, characterized in that, for sending a message wait indication from a voice mail server (151) in said time division multiplex network (PSTN) to said VOIP user (100) in said IP based telecommunication network (IPBN), it further comprises the steps of:
sending (300, 301) from the voice mail server (151) towards said VOIP user (100), via said media gateway controller (102), a message IAM containing a notification of presence or absence of voice messages, with some respective procedure code for notification, along with called digits designating said VOIP user (100),
preparing a SIP message NOTIFY and sending it (302) to the proxy server (104), when said media gateway controller (102) receives said message IAM containing some procedure code for notification along with called digits,
and then sending (304, 305) a message CONNECT and RELEASE, towards said voice mail server (151) in said time division multiplex network (PSTN), if the media gateway controller (102) receives a positive response from the proxy server (104).

3) A method according to claim 1, characterized in that, for interrogation by said VOIP user (100) in the voice mail server (151) in said time division multiplex network (PSTN), when said VOIP user (100) wants to listen to a voice message stored in said voice mail server (151), it further comprises the steps of:
sending (401) from the proxy server (104) in charge of said VOIP user (100) to the media gateway controller (102) a SIP message INVITE comprising no diversion header,
generating, in said media gateway controller (102), some procedure code for interrogation of the voice mail server (151), when said media gateway controller (102) receives said SIP message INVITE comprising no diversion header,
and then sending (403) the procedure code, in a message IAM, towards said voice mail server (151).

4) A method of providing a message wait service to a VOIP user in an IP based telecommunication network (IPBN), characterized in that, for sending a message wait indication from a voice mail server (151′) in a time division multiplex network to a VOIP user in an IP based telecommunication network, it comprises the steps of:
sending (501, 502) from a voice mail server (151′) towards said VOIP user, via a media gateway controller (102′), a message TCAP BEGIN containing a notification of presence or absence of voice messages, with some respective procedure code for notification, along with called digits designating said VOIP user,
preparing a SIP message NOTIFY and sending it (503) to a proxy server (104′), when said media gateway controller (102′) receives said message TCAP BEGIN containing some procedure code for notification along with called digits,
and then sending (505, 506) a message TCAP CONTINUE, towards said voice mail server (151′) in said time division multiplex network, if the media gateway server (102′) receives a positive response from the proxy server (104′).

5) A device (102) comprising processing means adapted to perform the steps of one the preceding claims.
